(19) United States
(12) Patent Application Publication
(10) Pub. No.: US 2012/0097423 A1
(43) Pub. Date: Apr. 26, 2012

(54) COAXIAL CABLE CENTER CONDUCTOR PRECOAT LAYER

(75) Inventor: ALAN JOHN AMATO, Cheshire, CT (US)

(73) Assignee: JOHN MEZZALINGUA ASSOCIATES, INC., East Syracuse, NY (US)

(21) Appl. No.: 13/219,852

(22) Filed: Aug. 29, 2011

Related U.S. Application Data
(60) Provisional application No. 61/405,953, filed on Oct. 22, 2010.

(51) Int. Cl. H01B 7/02

(52) U.S. Cl. 174/122 C; 174/120 R

(57) ABSTRACT

Disclosed herein is a coaxial cable that includes a center conductor. The coaxial cable further includes a precoat layer surrounding and adjacent to the center conductor. The precoat layer is configured to prevent moisture located circumferentially outward to the precoat layer from contacting the center conductor. Further, the coaxial cable includes a dielectric surrounding and adjacent to the precoat layer.

### RELATED APPLICATION

The present invention is a non-provisional claiming priority to a commonly owned U.S. Provisional Patent Application Ser. No. 61/405,953, filed Oct. 22, 2010, of Amato, entitled “Coaxial Cable Center Conductor Precoat Layer,” the disclosure of which is herein incorporated by reference to the extent not inconsistent with the present disclosure.

### FIELD OF THE INVENTION

The present invention relates to a coaxial cable. More particularly, the present invention relates to a coaxial cable that includes a center conductor precoat layer.

### BACKGROUND OF THE INVENTION

Typical coaxial cable includes a center conductor surrounded by a dielectric, an outer conductor surrounding the dielectric, and a jacket surrounding the outer conductor. One problem area in typical coaxial cables is the interface between the center conductor and the dielectric. This interface can be problematic because the dielectric is generally not only surrounding the center conductor but also attached to the center conductor in order to reduce movement of the center conductor in relation to the surrounding dielectric. This interface can also be problematic because water tends to migrate into the coaxial cable along this interface, which can detrimentally impact RF performance of the coaxial cable.

Thus, a coaxial cable that includes a precoat layer surrounding a center conductor would be well received in the art.

### BRIEF DESCRIPTION OF THE INVENTION

According to one aspect of the invention, a coaxial cable comprises: a center conductor; a precoat layer surrounding and adjacent to the center conductor, the precoat layer configured to prevent moisture located circumferentially outward to the precoat layer from contacting the center conductor; and a dielectric surrounding and adjacent to the precoat layer.

According to another aspect of the invention, a coaxial cable comprises: a center conductor; a precoat layer surrounding and adjacent to the center conductor, the precoat layer comprising at least one material selected from the group consisting of foamed polyethylene (PE), foamed polyolefin, fluoropolymer, polyvinylchloride (PVC), polyester, and polypropylene; and a dielectric surrounding and adjacent to the precoat layer.

According to yet another aspect of the invention, a coaxial cable comprises: a center conductor; a precoat layer surrounding and adjacent to the center conductor; and a dielectric surrounding and adjacent to the precoat layer; wherein the precoat layer is configured to bond to both the center conductor and the dielectric, and wherein the precoat layer forms a stronger bond with the dielectric than with the center conductor.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1A depicts a perspective view of an example coaxial cable that terminates with two example connectors;

FIG. 1B depicts a cross-sectional view of the example coaxial cable of FIG. 1A; and

FIG. 1C depicts a perspective view of a portion of the coaxial cable of FIGS. 1A and 1B with portions of each layer cut away.

### DETAILED DESCRIPTION OF THE INVENTION

Example embodiments of the present invention relate to a coaxial cable, and more particularly a coaxial cable having a center conductor precoat layer. In the following detailed description of some example embodiments, reference will now be made in detail to specific embodiments of the present invention, examples of which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. Example Coaxial Cable

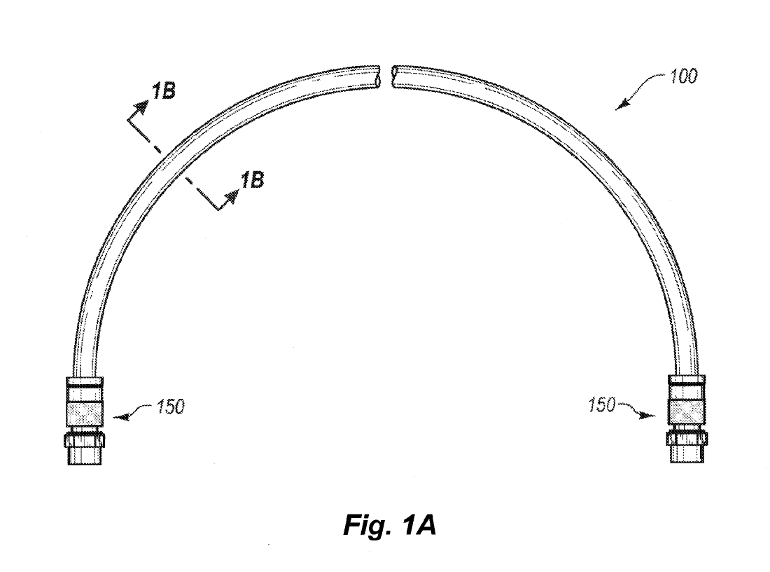

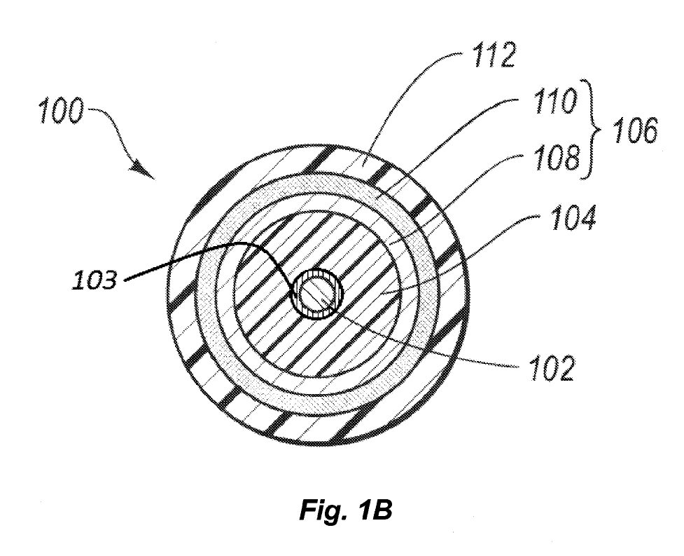

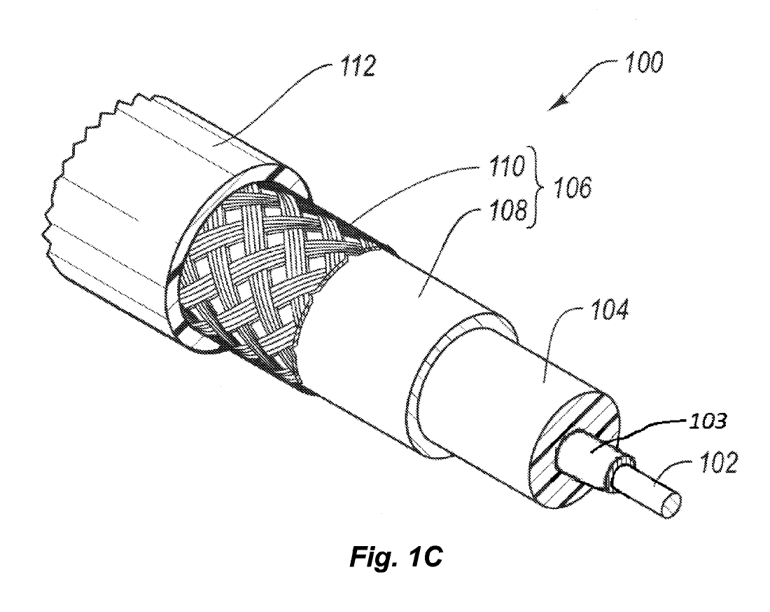

With reference first to FIG. 1A, an example coaxial cable 100 is disclosed. The example coaxial cable 100 can be any type of coaxial cable including, but not limited to, 50 Ohm and 75 Ohm coaxial cable. As disclosed in FIG. 1A, the example coaxial cable 100 is shown terminated on either end with an example connector 150. Although connectors 150 are disclosed in FIG. 1A as F-type male connectors, it is understood that cable 100 can also be terminated with other types of male and/or female connectors (not shown).

With continuing reference to FIG. 1A, and with reference also to FIGS. 1B and 1C, the coaxial cable 100 shown may be a standard-shield coaxial cable. However, unlike previous coaxial cables, the coaxial cable 100 includes a center conductor 102 surrounded by a precoat layer 103. A dielectric 104 surrounds the precoat layer 103. An outer conductor 106 including a conductive tape 108 and a conductive braid 110 both surround the dielectric 104. Further, a jacket 112 surrounds the outer conductor 106. As used herein, the phrase “surrounded by” refers to an inner layer generally being encased by an outer layer. However, it is understood that an inner layer may be “surrounded by” an outer layer without the inner layer being adjacent to the outer layer. The term “surrounded by” thus allows for the possibility of intervening layers. Each of these components of the example coaxial cable 100 will now be discussed in turn.

The center conductor 102 is positioned at the core of the example coaxial cable 100. The center conductor 102 is configured to carry a range of electrical current (amperes) and/or RF electronic digital signals. In some example embodiments, the center conductor 102 is formed from solid copper, copper-clad aluminum (CCA), copper-clad steel (CCS), or silver-coated copper-clad steel (SCCCS), although other conductive materials are possible. For example, the center conductor 102 can be formed from any type of conductive metal or alloy. In addition, the center conductor 102 can be solid, stranded, plated, or hollow, for example.

The precoat layer 103 surrounds the center conductor 102 and is surrounded by the dielectric 104. The precoat layer 103 is also adjacent to the center conductor 102 and the dielectric 104. The precoat layer 103 may be configured to reduce or prevent moisture from migrating into the coaxial cable 100 between the dielectric 104 and the center conductor 102. The precoat layer 103 may also be configured to bond the dielectric 104 to the center conductor 102. In one embodiment, the precoat layer 103 may be extruded onto the center conductor 102 during the manufacture of the coaxial cable 100. In this embodiment, the dielectric 104 may then be extruded over the precoat layer 103. In the embodiment shown, the precoat layer 103 is shown relatively thin compared with the dielectric layer 104 and the outer layers 108, 110, 112. However, it should be understood that this is not limiting. The precoat layer 103 may be thicker or thinner than the embodiment shown in the Figures.

This precoat layer 103 may be configured such that the axial shear adhesion strength of the bond interface between the center conductor 102 and the precoat layer 103 is less than the axial shear adhesive strength of the interface between the precoat layer 103 and the dielectric 104. During preparation of the coaxial cable for termination with the example connector 150, or other connector, a section of the dielectric 104 may be removed. Configuring the precoat layer 103 with a stronger bond with the dielectric 104 than with the center conductor 102 may enable the section of dielectric 104 to be removed with the underlying section of precoat layer 103 remaining attached, such that none or very little residual precoat layer 103 is left on the section of underlying center conductor 102.

The precoat layer 103 can be formed from various base materials including, but not limited to, polyvinylchloride (PVC), polypropylene, polyester, and various fluoropolymers such as fluorinated ethylene propylene (FEP), polyvinylfluoride (PVF), ethylene-chlorotrifluoroethylene (ECTFE) and polyvinylidene fluoride (PVDF), for example. Further, each of these base materials can be configured as a foamed material or a solid material. Furthermore, the ratio of the diameter of the precoat layer 103 to the diameter of the dielectric 104 may be greater than 1 to 3.71 in one embodiment.

Further, in at least some example embodiments, the precoat layer 103 can be formed from a base material of foamed polyethylene (PE) or foamed polyolefin. The use of foamed PE as a base material for a precoat layer has specific advantages over the use of solid PE in the area of reduction attenuation. The ratio of the density of the material of the precoat layer 103 to the density of the material of the dielectric 104 may further be between 1 to 1.10 and 1 to 1.85.

In addition to the above-listed base materials, the precoat layer 103 can also include a bonding additive, such as ethylene acrylic acid (EAA) for example, and an anti-tarnish agent. In at least some example embodiments, the precoat layer 103 layer includes about 96 percent of a solid base material, about 2 percent of the bonding additive, and about 2 percent of the anti-tarnish agent.

Each of the above-listed example formulations of the precoat layer 103 may enable the precoat layer 103 to reduce or prevent moisture from migrating from the outer jacket 112 into the center conductor 102. Thus, the precoat layer 103 prevents moisture from entering into the coaxial cable 100 between the dielectric 104 and the center conductor 102. Instead, moisture is retained between the precoat layer 103 and the dielectric 104. In other words, the precoat layer 103 may be configured to prevent moisture located circumferentially outward to the precoat layer 103 from contacting the center conductor 102. Further, the precoat layer 103 is configured to bond the dielectric 104 to the center conductor 102.

Furthermore, in other embodiments, the precoat layer 103 may not fully surround the center conductor 102. For example, the precoat layer 103 may in fact simply be a strip of material that runs the entire length of the coaxial cable 100 but encompasses less than the entire cross sectional circumference of the coaxial cable 100. In other words, the precoat layer 103 may be one or more strips of material located between the center conductor 102 and the dielectric 104.

The dielectric 104 surrounds the precoat layer 103, and generally serves to support and insulate the center conductor 102 from the tape 108. In some example embodiments, the dielectric 104 can be, but is not limited to, taped, solid, or foamed polymer or fluoropolymer. For example, the dielectric 104 can be foamed PE.

The tape 108 of the outer conductor 106 surrounds the dielectric 104 and generally serves to minimize the ingress and egress of high frequency electromagnetic fields to/from the center conductor 102. For example, in some applications, the tape 108 can shield against electromagnetic fields that are greater than or equal to about 50 MHz. The tape 108 is a laminate tape that can include, but is not limited to, the following layers: aluminum/polymer, bonding agent/aluminum/polymer, bonding agent/aluminum/polymer/aluminum, or aluminum/polymer/aluminum, for example. It is understood, however, that the discussion herein of tape is not limited to tape having any particular combination of layers.

The braid 110 of the outer conductor 106 surrounds the tape 108 of the outer conductor 106. The braid 110 generally serves to minimize the ingress and egress of low frequency electromagnetic fields to/from the center conductor 102. For example, in some applications, the braid 110 can shield against electromagnetic fields that are less than about 50 MHz. The braid 110 can be formed from interwoven, fine gauge aluminum or copper wires, such as 34 America wire gauge (AWG) wires, for example. It is understood, however, that the discussion herein of braid is not limited to braid formed from any particular type or size of wire.

The jacket 112 surrounds the outer conductor 106, and generally serves to protect the internal components of the coaxial cable 100 from external contaminants, such as dust, moisture, and oils, for example. As noted elsewhere herein, however, the jacket 112 may not always completely repel moisture from entering the coaxial cable 100. Contact with moisture results in the corrosion of the conductive components of the coaxial cable 100. In a typical embodiment, the jacket 112 also functions to protect the coaxial cable 100 (and its internal components) from being crushed or otherwise misshapen from an external force. The jacket 112 can be formed from a relatively rigid material such as, but not limited to, PE, high-density polyethylene (HDPE), low-density polyethylene (LDPE), or linear low-density polyethylene (LLDPE), or some combination thereof. The jacket 112 may instead be formed from a relatively less rigid and more pliable material such as, but not limited to, foamed PE, polyvinyl chloride (PVC), or polyurethane (PU), or some combination thereof. The actual material or combination of materials used might be indicated by the particular application/environment contemplated.

### II. Alternative Coaxial Cables

Although the example embodiments are described in the context of a standard-shield coaxial cable, it is understood that other cable configurations may likewise benefit from the precoat layer 103 disclosed herein. For example, the precoat layer 103 may be employed in tri-shield coaxial cable (where the outer conductor includes one braid layer and two tape layers), quad-shield coaxial cable (where the outer conductor includes two braid layers and two tape layers), and messengered coaxial cable (where the coaxial cable includes a messenger wire embedded in the jacket that provides support in situations where the cable aerially spans long distances, such as 75 feet or more). Furthermore, the outer conductor 106 may not include braids, but may include a solid wall of copper, aluminum, copper tape or aluminum tape. In other words, the present invention is not limited to the type of coaxial cable. The principles described herein may be applied to any coaxial cable that includes a center conductor and a dielectric.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A coaxial cable comprising:
a center conductor;
a precoat layer surrounding and adjacent to the center conductor, the precoat layer configured to prevent moisture located circumferentially outward to the precoat layer from contacting the center conductor; and
a dielectric surrounding and adjacent to the precoat layer.

2. The coaxial cable of claim 1, further comprising:
a tape surrounding the dielectric;
a braid surrounding the tape; and
a jacket surrounding the braid.

3. The coaxial cable of claim 1, wherein the precoat layer is configured to bond to both the center conductor and the dielectric.

4. The coaxial cable of claim 1, wherein an axial shear adhesion strength of a bond interface between the center conductor and the precoat layer is less than an axial shear adhesive strength of a bond interface between the precoat layer and the dielectric.

5. The coaxial cable of claim 1, wherein the precoat layer is made from at least one base material selected from the group consisting of polyvinylchloride (PVC), polypropylene, polyester, fluorinated ethylene propylene (PEP), polyvinylfluoride (PVF), ethylene-chlorotrifluoroethylene (ECTFE), polyvinylidene fluoride (PVDF), foamed polyethylene (PE) or foamed polyolefin, solid polyethylene (PE), and solid polyolefin.

6. The coaxial cable of claim 1, wherein the precoat layer includes a bonding additive.

7. The coaxial cable of claim 6, wherein the bonding additive is ethylene acrylic acid.

8. The coaxial cable of claim 6, wherein the precoat layer includes an anti-tarnish agent.

9. The coaxial cable of claim 8, wherein precoat layer includes about 96 percent of a base material, and about 2 percent of a bonding additive, and about 2 percent of an anti-tarnish agent.

10. The coaxial cable of claim 1, wherein the coaxial cable is selected from the group consisting of a standard-shield coaxial cable, a tri-shield coaxial cable, quad-shield coaxial cable, and messengered coaxial cable.

11. A coaxial cable comprising:
a center conductor;
a precoat layer surrounding and adjacent to the center conductor, the precoat layer comprising at least one material selected from the group consisting of foamed polyethylene (PE), foamed polyolefin, fluoropolymer, polyvinylchloride (PVC), polyester, and polypropylene; and
a dielectric surrounding and adjacent to the precoat layer.

12. The coaxial cable of claim 11, further comprising:
a tape surrounding the dielectric;
a braid surrounding the tape; and
a jacket surrounding the braid.

13. The coaxial cable of claim 11, wherein the precoat layer is configured to bond to both the center conductor and the dielectric.

14. The coaxial cable of claim 11, wherein an axial shear adhesion strength of a bond interface between the center conductor and the precoat layer is less than an axial shear adhesive strength of a bond interface between the precoat layer and the dielectric.

15. The coaxial cable of claim 11, wherein the precoat layer is configured to prevent moisture located circumferentially outward to the precoat layer from contacting the center conductor.

16. The coaxial cable of claim 11, wherein the precoat layer includes a bonding additive.

17. The coaxial cable of claim 16, wherein the bonding additive is ethylene acrylic acid.

18. The coaxial cable of claim 16, wherein the precoat layer includes an anti-tarnish agent.

19. The coaxial cable of claim 18, wherein precoat layer includes about 96 percent of a base material, and about 2 percent of a bonding additive, and about 2 percent of an anti-tarnish agent.

20. A coaxial cable comprising:
a center conductor;
a precoat layer surrounding and adjacent to the center conductor; and
a dielectric surrounding and adjacent to the precoat layer;
wherein the precoat layer is configured to bond to both the center conductor and the dielectric, and wherein the precoat layer forms a stronger bond with the dielectric than with the center conductor.
